(19) United States
(12) Patent Application Publication
(10) Pub. No.: US 2006/0141254 A1
(43) Pub. Date: Jun. 29, 2006

(54) Lcst polymers

(76) Inventors: Inge Kramer, FReising (DE); Thadeus Schauer, Althengsteltt (DE); Matthias Schrod, Eppertshausen (DE); Mark Entenmann, Fellbach (DE)

Correspondence Address: Scott R. Cox;Lynch Cox Gilman & Mahan, 500 W. Jefferson St., Ste. 2100, Louisville, KY, 40202, US

(21) Appl. No.: 10/535,767

(22) PCT Filed: Nov. 21, 2003
(86) PCT No.: PCT/EP03/13098

§ 371 Date: Nov. 8, 2005

(30) Foreign Application Priority Data
Nov. 21, 2002 (DE) 102 54 430.1

(51) Int. Cl. B32B 5/16

(52) U.S. Cl. 428/403; 428/411.1

(57) ABSTRACT

A description is given of polymers of the general formula 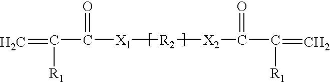
in which R₁ (identical or different at each occurrence) is hydrogen or a methyl group, X₁ and X₂=—O—, —S— or —NH— and X₁ additionally is a single bond if the first atom in R₂ is not a carbon atom, and R₂ is one of the radicals indicated below:
a) a copolymer radical (Cop) containing at least two structural units —(—O—C₂H₄)ₙ— (ethylene oxide=EO) and —(—O—C₃H₆—)ₙ— (propylene oxide=PO) or —(—O—C₄H₈)ₙ— (butylene oxide=BuO) and —(—O—CH₂—)ₙ— (methylene oxide=MeO) in a molar ratio of 5 to 95:95 to 5, in which n (identical or different for each structural unit) is approximately 1 to 1000;
   b) 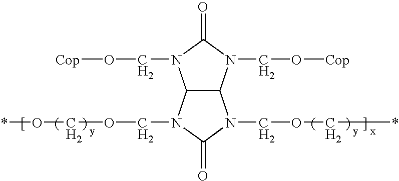 in which Cop is a copolymer radical as defined in (a), and x=1 to 5 and y=1 to 20;
   c) 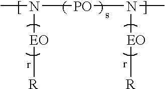 in which R is an alkyl group, r=(identical or different at each occurrence) 1 to 1000 and s=1 to 500;
   d) 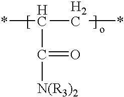
in which o=10 to 4000 and R₃ (identical or different at each occurrence) is hydrogen or alkyl groups having 1 to 5 carbon atoms;
   e) 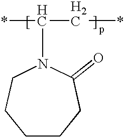 in which p=5 to 2000; or
   f) 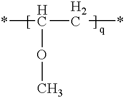 in which q=10 to 4000. A description is also given of processes for their preparation and also of their use for coating particles and nonparticulate substrate surfaces.

The invention relates to LCST (lower critical solution temperature) polymers. This term is used to refer to polymers which are soluble in a liquid medium at a low temperature but above a certain temperature (the LCST temperature) precipitate from the liquid medium. LCST polymers have different chemical compositions. The best-known LCST polymers are polyalkylene oxide polymers, examples being polyethylene oxide (PEO) or polypropylene oxide (PPO) polymers, but also (PEO)-(PPO) copolymers, particularly PEO-PPO-PEO block copolymers. Other LCST polymers are poly(N-isopropyl-acrylamide)-ethyl-(hydroxyethyl)-cellulose derivatives, poly(N-vinylcaprolactam) derivatives and poly(methyl vinyl ether) derivatives.

The first-mentioned polymers are described for example in WO 01/60926 A1. That publication relates to a process for coating substrate surfaces (particle surfaces and nonparticulate substrate surfaces) with LCST polymers, for which an LCST polymer is dissolved in a solvent at a temperature below the LCST temperature, this solution is mixed with the substrate surfaces to be coated, and the resultant mixture is heated to above the LCST temperature until the deposition of LCST polymers on the substrate surfaces begins. The deposited LCST polymer can be immobilized by providing it with functional groups which allow substantially irreversible adsorption on the substrate surface. The functional groups may be selected from acid groups, hydroxyl groups, amino groups, phosphate groups, mercaptan groups, siloxane groups or hydrophobic groups. Further, the LCST polymers may be provided with functional groups which, following deposition of the LCST polymers on the particles, allow the crosslinking of the LCST polymers in a crosslinking reaction. Functional groups of this kind may be selected from carboxylic acid group derivatives, chloroformate groups, amino groups, isocyanate groups, oxirane groups and/or free-radically crosslinkable groups, with the crosslinking reaction being initiated, inter alia, by a change in the pH of the solution.

Free-radical crosslinking is less preferred than cross-linking through a change in pH. The examples specify merely the enveloping of various pigment particles (TiO₂, Fe₂O₃, Cu phthalocyanine blue, and semiconductor wafers with a silicon dioxide surface) with PEO-PPO-PEO block copolymers. Fixing of the copolymers deposited on the substrate surfaces is not elucidated.

The use of LCST polymers for enveloping superpara-magnetic particles is known, further, from WO 97/45202. These particles comprise a core of a first polymer, an inner layer of a second polymer, which coats the core and in which a magnetic material is dispersed, and an outer layer of a third polymer, which coats the magnetic layer and is capable of reacting at least one biological molecule, the second polymer at least being heat-sensitive and having an LCST temperature of 15 to 65° C. The second polymer is obtained preferably by polymerizing (1) a water-soluble acrylamide monomer, such as N-isopropylacrylamide (NIPAM), (2) at least one crosslinking agent, such as N,N-methylenebisacrylamide and (3) at least one functional cationic and water-soluble monomer different than the monomer (1), e.g., the chloride of 2-aminoethyl methacrylate. A further preferred polymer is [poly(N-isopropylacrylamide)] (PNIPAM).

Patent Abstracts of Japan, Vol. 009 No. 188 (C295) (1985) page 107=JP 60 058 237 A describes the encapsulation of inorganic particles. The aim is to prepare a stable particle dispersion. The inorganic particles are suspended in water and contacted below the LCST temperature with an aqueous solution of the LCST polymer. When the temperature of the resulting system is raised, a layer of the LCST polymer is deposited on the inorganic particles. The resultant particle suspension is admixed with a free-radically polymerizable monomer, an initiator and, if desired, an emulsifier, and an emulsion polymerization is carried out, giving encapsulated particles. Now, additionally, there is an outer layer, consisting of the polymerized monomer layer; accordingly, the function of the LCST polymer layer is only to facilitate the penetration of monomer residues.

The polymerizable monomer, then, is reacted with the LCST polymer that is already on the particles, or the water-soluble polymer is enveloped with a layer of the polymer obtained from the polymerizable monomer. This process has the disadvantage that the graft attachment takes place only on the active centers of the pre-deposited LCST polymer, and so the envelopment is nonuniform and heterogeneous and does not constitute a complete barrier.

Moreover, it is necessary to add a monomer to the dispersion of the coated particles in order to initiate crosslinking. In the majority of cases the monomer is never fully consumed, and so a certain fraction of the monomer remains in the crosslinked structure. Subsequent emission of the “dissolved” monomers from the polymer is undesirable, since the monomer is injurious to health.

Furthermore, disadvantages in the coating system are anticipated as a result of the detachment of the copolymerized emulsifier if the pigment comes into contact with solvents.

WO 92/20441 describes a process for generating encapsulated particles, the particles comprising a core surrounded by a coacervate coating. In this process an aqueous solution of an LCST polymer is contacted, at a temperature of reversible insolubilization (TRI), of T1, with a dispersion of the particles at a temperature of T2, which is lower than T1, and then the dispersion is heated to a temperature above T1, thereby depositing the LCST polymer as a coacervate around the particles. Subsequently an agent for lowering the TRI is added to the solution, thereby lowering the TRI of the LCST polymer in the solution to a temperature T3, which is lower than T1, and then either the dispersion is cooled to a temperature between T3 and T1 and is held at this temperature, or the particles are separated from the dispersion at a temperature of more than T3. As agents for lowering the TRI it is possible to use electrolytes and water-miscible organic liquids in which the LCST polymer is not soluble.

LCST polymers used are preferably synthetic polymers (homopolymers or copolymers) with hydrophilic monomers. Suitable LCST monomers are acrylic or vinyl compounds. Where LCST copolymers are used, the comonomer is commonly hydrophilic and may be nonionic or ionic. Suitable nonionic monomers are certain aryl or vinyl compounds. Examples of anionic or cationic monomers are acrylic acid derivatives or dialkylaminoalkyl acrylates. These compounds, however, are already saturated at the ends, and so crosslinking reactions are no longer possible.

LCST polymers are also known, for example, from EP 0 629 649 A1. They are used as rheofluidizing additives and antisettling agents in diaphragm wall construction, for wells in the oil industry, and as hydraulic fluids and lubricants.

EP 0 718 327 A2 discloses universally compatible pigment dispersants composed of methyl methacrylate and an acrylate or methacrylate. These polymers, however, serve only for dispersing pigments, but not for enveloping pigments.

The object on which the invention was based was to provide LCST polymers which on cooling no longer detach from a substrate surface but instead remain firmly joined to it. The polymers are therefore intended to be used without added emulsifiers or monomers, so that no additives can leach from the defined polymer layer.

This object is achieved in accordance with the invention by means of LCST polymers of the general formula: 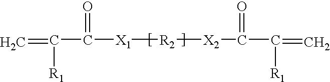
in which R₁ (identical or different at each occurrence) is hydrogen or a methyl group, X₁ and X₂ (identical to or different from one another)=—O—, —S— or —NH— and X₁ additionally is a single bond if the first atom in R₂ is not a carbon atom, and R₂ is one of the radicals indicated below:
a) a copolymer radical (Cop) containing at least two structural units —(—O—C₂H₄)ₙ— (ethylene oxide=EO) and —(—O—C₃H₆—)ₙ— (propylene oxide=PO) or —(—O—C₄H₈)ₙ— (butylene oxide=BuO) and —(—O—CH₂—)ₙ— (methylene oxide=MeO) in a molar ratio of 5 to 95:95 to 5, in which n (identical or different for each structural unit) is approximately 1 to 1000;
b) 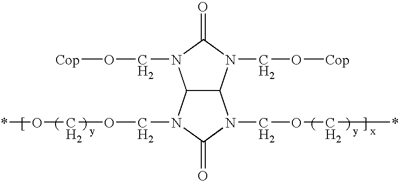
in which Cop is a copolymer radical as defined in (a), x=1 to 5 and y=1 to 20;
c) 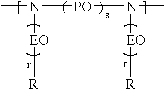
in which R is an alkyl group, r (identical or different at each occurrence) 1 to 1000 and s=1 to 500;
d) 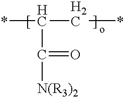
in which o=10 to 4000 and R₃ (identical or different at each occurrence) is hydrogen or alkyl groups having 1 to 5 carbon atoms;
e) 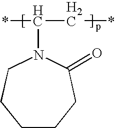
in which p=5 to 2000;
f) 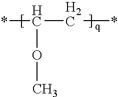
in which q=10 to 4000.

It has surprisingly been found that the polymers of the invention are irreversibly immobilized on the substrate surface after polymerization on the acrylic or methacrylic side chain. The immobilization is far greater than that of LCST polymers in which the end groups are composed, for example, of simple vinyl groups or other groups with double bonds.

Other polymerized units, such as vinylacetic acid, oleic acid, fumaric acid, maleic acid and polyethylene glycol monovinyl ether, are less suitable as end groups.

The polymers of the invention commonly have an LCST in the range from 0 to 70° C., which is dependent on factors including the following:
molar ratio of the hydrophobic and hydrophilic fractions of the LCST polymer,
molar mass of the LCST polymer,
number of polymerizable and ionisable groups,
concentration of the polymer,
pH and ionic strength of the medium.

The LCST polymers are composed of polar and nonpolar or hydrophilic and hydrophobic segments. The LCST can be tailored by varying these individual segments and also the overall chain length.

Following the polymerization with the acrylic or methacrylic end groups, the LCST polymers of the invention can be used as dispersants fixed on the substrate surfaces. Among other things, this makes the expensive step of pigment dispersion cheaper, since the pigment carries its dispersant with it. Further, the pigments thus coated form agglomerates to a lesser extent than do untreated pigments, so that dispersion is easier to carry out, resulting in an additional reduction in costs.

Dispersants are surface-active substances which facilitate the dispersion of a pulverulent substance, e.g., a pigment or filler, in a liquid dispersion medium, by lowering the surface tension between two components. In the course of pigment grinding they thereby facilitate the mechanical disruption of the secondary particles which are present in the form of agglomerates, into primary particles. Moreover, they protect the primary particles formed from reagglomeration or flocculation by virtue of complete wetting and the formation of a protective colloid shell or an electrochemical double layer.

Since the LCST polymers of the invention are transparent or transluscent in visible light, they are able to form a complete envelope around particles, without the color of the particles themselves being affected. Further, in paints, the pigments thus coated display the full color strength, since by virtue of the LCST polymer coating they do not form agglomerates.

Preferred LCST polymers fall into groups (a) and (c) Preferably the radical —(C₃H₆)— radical in (a) and (c) is an isopropyl radical and the radical —(C₄H₈)— in (a) is an isobutyl radical.

The preferred LCST polymers in group (a) are block copolymers, the structural units -(EO)- and -(PO)- on the one hand and the structural units -(BuO)- and -(MeO)- on the other hand being present in blocks with n=3 to 100.

Block copolymers are composed of blocks of homosequences linked to one another via the ends. Graft polymers are composed of what is called a homopolymeric backbone, from which polymer chains of other homopolymers branch out.

The blocks with the structural units -(-PO)- and -(-BuO-)- are preferably disposed between the blocks with the structural units -(-EO)- and -(-MeO-), respectively.

These block copolymers are referred to for the sake of simplicity as PEO-PPO-PEO block copolymers. A triblock copolymer having the block sequence PEO-PPO-PEO customarily has a PEO weight fraction of about 5% to 85% by weight and number-average molar masses (MN) of 200 to 50,000 g/mol.

Alternatively, the different structural units can be randomly distributed.

The molar ratio between the -(EO)- structural units and -(PO)- structural units is preferably about 10 to 60 40 to 90.

The LCST polymers of the invention of versions (a) to (f) can be prepared by reacting a compound of the general formula HO—[R₂]—OH, in which R₂ is as defined above, with a compound of the formula
(a) 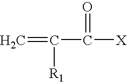
in which R₁ is as defined above and X is OH, halogen, preferably chlorine, or a lower alkoxy group, in a molar ratio of 1:2, or (b) with the anhydride of the corresponding acid in a molar ratio of 1:1.

The starting polymers for the LCST polymers of product versions (a) to (c) are in some cases available commercially. Additionally, however, they can be prepared as follows:

For version (a):

The copolymers can be prepared by starting from a compound which is already present in macromolecular form and continuing the polymerization using a polymer of a different kind. The polymerization may take place either in solution in water or in an organic solvent, in emulsion or suspension or by direct reaction of the components in bulk or in powder form in the melt, with or without a catalyst, preferably in a one-stage process.

For version (b):

These copolymers are star-shaped and contain as their central linking unit a glycoluril group. They can be prepared as follows:

A glycouril unit (Powderlink 1774) is reacted with PEO methyl ether and PPO butyl ether so as to link one or more PEO units to one or more PPO units.

Compounds of this kind and their use for coating substrate surfaces, such as pigments, are described for example in the following publications: DE 100 38 147 A1, DE 100 64 240.3 and DE 101 63 985.6.

For version (c)

The copolymers are prepared with the aid of tosylates. As a result it is possible to link the OH-terminated polyethers (PEO/PPO) with amines. The polyethers are reacted in this case with tosyl chloride (p-toluene-sulfonyl chloride), giving polyether tosylates. Since the tosyl group is a very good leaving group, the polyether tosylates can be reacted with primary amines. Thus it is possible, by way of an aliphatic or aromatic diamine, to link, for example, a PEO unit with a PPO unit. Another possibility is the reaction of PPO diamine with PEO tosylate. In this way a three-block copolymer is obtained. In order to prevent advancement reactions, which would result in undefined products, the polyethers ought to contain only one free OH group.

For versions (d) to (f) the corresponding monomers are used.

The LCST polymers of the invention can be used for coating particles and nonparticulate substrate surfaces. The particles that are suitable in accordance with the invention include pigments, fillers, and nano-particles. Pigments are pulverulent or platelet-shaped colorants which in contrast to dyes are insoluble in the surrounding medium (DIN 55943: 1993-11, DIN:EN 971-1: 1996-09). Pigments influence or determine the coloring and for reasons of cost are used in as small amounts as possible. Owing to forces of interaction it is possible for the pigment particles to agglomerate, particularly during incorporation into the matrix material. This results, for example, in quality detractions in the resulting paint, as a consequence, inter alia, of deficient color strength, sedimentation or phase separation.

Preferred pigments are titanium dioxide, iron oxide, zinc oxide, carbon black, Cu phthalocyanine pigments, platelet-shaped pigments, such as mica (with or without oxidic and metallic coatings) or aluminum. Fillers which can be used include, for example, barium sulfate and talc. Nanoparticles which can be used include iron oxide, titanium dioxide and silicon dioxide particles. The particles also include microfibers, such as glass, carbon, textile and polymer fibers.

The substrate surfaces may also be nonparticulate surfaces, such as those of glass, metal and semiconductors, for example. Particularly preferred surfaces are silicon dioxide wafers which are used in the semiconductors industry.

The LCST polymers of the invention are preferably contacted in a liquid medium (e.g., in an aqueous or organic medium) at below the LCST temperature with the particles or the nonparticulate substrate surfaces, and then the temperature is raised to above the LCST temperature and the polymers are polymerized by the double bonds at this temperature or a higher temperature on the surface of the particles or on the nonparticulate substrate surfaces.

The synthesis of product version (a) takes place by reacting commercially available PEO-PPO-PEO block copolymers which have terminal OH groups with acrylic or methacrylic acid derivatives, thereby introducing polymerizable double bonds. The introduction can take place by means of the following derivatives: chlorides, esters, anhydrides, amides or free acids, and is acidically or basically catalyzed. This esterification or transesterification can be carried out in a solvent at about 0 to 100° C., but can also be carried out in bulk (without solvent). In order to inhibit unwanted polymerization, small amounts of a polymerization inhibitor are added to the reaction mixture.

The synthesis of product version (b) takes place by reacting the polyether-modified glycoluril with acryloyl or methacryloyl chloride, thereby introducing polymerizable double bonds. This reaction can be carried out in a solvent at about 0 to 30° C., but can also be carried out in bulk (without solvent). One possibility of introducing a double bond is to react the product mixture, which ought to contain at least two PEO/PPO segments, with ethylene glycol. After the reaction of the first OH group with the glycoluril unit, the second free OH group of the ethylene glycol is sterically shielded by the polymer chains, and so there ought not to be any reaction with the second glycoluril unit. The free OH group that remains can then be reacted with compounds possessing less steric bulk, such as with acryloyl chloride, for example. The synthesis of product version (c) takes place by reacting the 3-block copolymer, obtained with a tosylate method, on the NH group with acryloyl or methacryloyl chloride, giving polymers containing polymerizable acrylic or methacrylic double bonds.

Via this synthesis route it has been possible to link a PPO diamine (2000 g/mol) with PEO (750 g/ml) and to introduce double bonds with acryloyl chloride. In the reaction of PEO tosylate with PPO diamine the temperatures are about 150° C. The precise synthesis instructions are given in Example 5.

The synthesis of product version (d) to (f) takes place by an anionic polymerization of the corresponding monomers in solution. In this case a sodium-naphthalene solution serves as initiator. As a result of the use of this initiator system, electron transfer to a fraction of the monomers results in the formation of what are referred to as free-radical anions. The free-radical anions formed combine very rapidly to form dianions, and so chain growth will take place on two sides.

An advantage of this polymerization process is that the resulting polymer has a very narrow molar mass distribution. This can be influenced and predicted through the choice and composition of the reactants.

The polymerization is terminated with electrophilic substances. The addition of acryloyl chloride or methacryloyl chloride to the reaction solution not only results in the ending of the polymerization but at the same time introduces the acrylic or methacrylic end group.

The invention further provides particles or nonparticulate substrate surfaces that are coated with the polymerized LCST polymer.

The invention is elucidated, without restriction, by the examples which follow.

### EXAMPLE 1

### Version (a)

### Modification of Market-Standard LCST Polymers for Immobilization

In principle it is possible to react LCST polymers containing OH or NH₂ groups with acryloyl chloride. The resulting modified LCST polymers contain double bonds via which they can be free-radically polymerized.

The present example illustrates the modification of HOPEOPPOPEOOH copolymers.

20 g of a PEO-PPO-PEO block copolymer (4400 g/mol, 2 OH end groups; commercial product Synperonic® L121) are weighed out into a two-necked round-bottomed flask and mixed with 3 ml of triethylamine (1.2-fold excess) with the aid of a stirrer. The mixture is conditioned to about 10° C. (waterbath). Using a dropping funnel, 2 ml (1.2-fold excess) of acryloyl chloride are slowly added dropwise, with vigorous stirring and cooling, in the course of which the temperature ought not to rise above 25 to 30° C. The vapors which form (HCl, a little acrylamide) are taken off into the waste-air system. The addition of the acryloyl chloride is followed by stirring, accompanied by cooling, until the evolution of heat and vapor is at an end (about 30 minutes). For complete reaction of the acryloyl chloride, heating is then continued at 30° C. for 2 h more, with stirring, after which the mixture is cooled to room temperature and rinsed 3 times with water at room temperature and the product is isolated by centrifugation.

The resulting product, with an LCST temperature of 8° C., can normally be used in the wet state; in other words, no further working up is normally necessary. The amount of polymer is determined as the solids content, and in the application the LCST polymer is used with a relative concentration of 5% to 10% by weight, based on solids content.

The polymer can be dried under an oil-pump vacuum at a maximum of 35 to 40° C., in order to prevent crosslinking. For complete drying it has proven appropriate to take up the polymer with ethanol and then to strip off the ethanol. Working up can also be carried out in the manner described for the reaction of PEONHPPONHPEO. In that case the polymer is dissolved in chloroform. The solution is extracted by shaking with, respectively, a little dilute HCl solution, dilute NaOH solution and saturated NaCl solution. The organic phase is dried over sodium sulfate and the chloroform is removed on a rotary evaporator (waterbath <25° C.).

### EXAMPLE 2

### Version (a)

The reaction of the block copolymer of Example 1 can also take place in accordance with the prior art by transesterification. This is done by mixing 1 mol of the polymer with up to 4 mol, preferably 2.4 mol, of methacrylate, or methyl acrylate. The ester can also be added in portions or continuously during the reaction. Further, the mixture is admixed with 0.1% to 5% by weight of transesterification catalyst (sulfuric acid, hydrochloric acid, p-toluenesulfonic acid, dodecyl-benzenesulfonic acid, alkali (ne earth) (hydr) oxides or metal alkoxides). The transesterification is carried out at liquid-phase temperatures of 80 to 120° C. In order to prevent unwanted polymerizations the reaction is carried out advantageously in the presence of small amounts of commercially customary polymerization inhibitors (e.g., hydroquinone monoalkyl ethers, 2,6-di-t-butylphenol, N-nitrosamines, phenothiazine or phosphoric esters). These compounds are used in amounts of 0.01% to 2.0%, based on the mass of the acrylic ester. The product obtained has an LCST of 8° C.

### EXAMPLE 3

### Version (a)

The procedure of Example 2 is repeated with the difference that 1 mol of the block copolymer is reacted with 2.4 mol of acrylic acid. The esterification is carried out in the presence of a solvent with which the water can be removed azeotropically, such as n-hexane, n-heptane and cyclohexane, or aromatics, such as benzene, toluene and the xylene isomers, and what are called special-boiling point spirits, which have boiling limits of between 70 and 140° C. The product obtained has an LCST of 8° C.

### EXAMPLE 4

### Version (b)

The glycoluril-LCST polymers can be synthesized either in solution or in bulk. In both cases the products obtained are the same.

Synthesis in Solution:

A reaction vessel is charged with 105 g of PEO/PPO block copolymer having a molecular weight of about 2000 g/mol; manufacturer: Sigma-Aldrich Chemie GmbH, Deisenhofen; 3 g of glycoluril Powderlink® 1174, manufacturer: Cytec Industries B. V., Neus; and 400 ml of toluene, and this initial charge is heated to 135° C. under nitrogen, and traces of moisture are removed by azeotropic distillation. After an hour the reaction is initiated by adding 0.2 g of p-toluenesulfonic acid under a vacuum of 530 mbar and continuously adding fresh toluene dropwise. After about five hours 1.45 g of ethylene glycol are added. The reaction mixture is left to react under unchanged conditions for a further five hours.

After the mixture has cooled, 2.8 g of triethylamine are added and 2.5 g of acryloyl chloride are added dropwise with cooling to 25-30° C. The reaction solution is poured into trays and dried to constant mass in a vacuum drying oven at a maximum of 50° C. The product obtained has an LCST of 8° C.

### COMPARATIVE EXAMPLE

The procedure of Example 4 (glycoluril version) was repeated with the difference that the last reaction step, namely the introduction of the polymerizable double bond into the polymer, was carried out not with acryloyl chloride but instead with 4-pentenoyl chloride (manufacturer: Sigma-Aldrich Chemie, Deisenhofen). In this case 3.26 g were used for the reaction in solution and 3.26 g of 4-pentenoyl chloride for the reaction in bulk; the other reactant proportions were not changed. The product obtained has an LCST of 0 to 2° C.

### EXAMPLE 5

### Version (c)

a) Synthesis of PEO Tosylate

25 g (33.3 mmol) of PEO monomethyl ether (750 g/mol) and 3.54 g (35 mmol) of triethylamine are dissolved in chloroform and the solution is cooled to about 0 to 5° C. 6.67 g (35 mmol) of tosyl chloride (in solution in chloroform) are added dropwise, and the solution is stirred at room temperature for about 15 h. The solution is extracted by shaking with, respectively, a little dilute HCl solution and saturated NaCl solution. The organic phase is dried over sodium sulfate and the chloroform is removed on a rotary evaporator.

b) Reaction of PEO Tosylate (a) with PPO Diamine to Give PEONHPPONHPEO Copolymer

A round-bottomed flask is charged with the PEO tosylate (4.5 g/5 mmol), the PPO diamine (2000 g/mol; 5 g/2.5 mmol) and 2 ml of triethylamine (excess, because of the boiling point of 89° C.). The mixture is heated under reflux with vigorous stirring at 150° C. for 3 h. The product is dissolved in chloroform and extracted by shaking with, respectively, a little water, dilute HCl solution, dilute NaOH solution and saturated NaCl solution. The organic phase is dried over sodium sulfate and the chloroform (along with residual triethylamine) is removed on a rotary evaporator.

c) Reaction of the PEONHPPONHPEO Copolymer (b) with Acryloyl Chloride

3 g (0.86 mmol) of PEONHPPONHPEO copolymer and 0.15 g (1.71 mmol) of acryloyl chloride are dissolved in chloroform and the solution is cooled to about 10 to 15° C. 0.17 g (1.71 mmol) of triethylamine is added dropwise and the solution is stirred at room temperature for about 15 h. The solution is extracted by shaking with, respectively, a little dilute HCl solution, dilute NaOH solution and saturated NaCl solution. The organic phase is dried over sodium sulfate and the chloroform is removed on a rotary evaporator (waterbath at 25° C.).

The products synthesized were analyzed by means of ¹H NMR spectroscopy and GPC, the protons of the CH═CH₂ group being clearly in evidence at between 5.5 and 6.5 ppm. The GPC elution diagrams showed the higher molar mass of the products as compared with the reactants. The products still, however, contained a reactant fraction with a lower molar mass. The LCST temperature of a 0.5% strength aqueous solution is 1 to 2° C.; at higher polymer concentrations a slight turbidity is in evidence even at 0° C.

### EXAMPLE 6

### Version (d)

Synthesis of N,N-Diethylacrylamide LCST Polymers

a) Preparation of the Initiator Solution

In a 2 1 three-necked flask with reflux condenser, on which a drying tube is mounted, and nitrogen feed line, 1000 ml of tetrahydrofuran, distilled a number of times over sodium, 40 g of naphthalene and 6 g of sodium chips are stirred at 20° C. under an absolutely dry nitrogen atmosphere. Over the course of 2 h the sodium passes into solution to form the addition compound, which is deep green in color. The solution prepared is then 0.25 molar with respect to sodium.

b) Implementation of the Polymerization

The operations below must likewise be carried out with careful exclusion of air and moisture.

A 1 liter three-necked flask is charged under a pure nitrogen atmosphere with 300 ml of tetrahydrofuran freshly distilled over sodium. Then 20 ml of the naphthalene-sodium solution from a) are transferred to a dropping funnel mounted on the flask, and the final impurities in the flask are removed using a few drops of this solution. As soon as the green color is maintained, 500 ml of this 0.25 M solution are run in. Subsequently, with vigorous stirring and over the course of 30 minutes, a solution of 317 g of N,N-diethylacrylamide (2.5 mol) in 1000 ml of tetrahydrofuran is added dropwise. The solution immediately changes color. By means of external cooling the temperature is held at 15-20° C., and the N,N-diethylacrylamide added dropwise undergoes polymerization practically within a few seconds. After the end of the addition of N,N-diethylacrylamide the polymerization is terminated by addition of an excess of 12 g of acryloyl chloride. The reaction mixture is worked up by adding 10 ml of methanol before the solvent is stripped off. The product obtained has an average molar mass of about 4700 g/mol and an LCST of about 39° C.

### EXAMPLE 7

### Version (e)

Synthesis of N-Vinylcaprolactam LCST Polymers

The polymerization of 348 g (2.5 mol) of N-vinylcaprolactam takes place in the same way as that of the N,N-diethylacrylamide. The product obtained has an average molar mass of about 5700 g/mol and an LCST of about 32° C.

### EXAMPLE 8

### Version (f)

Synthesis of Methyl Vinyl Ether LCST Polymers

The polymerization of 145 g (2.5 mol) of methyl vinyl ether takes place in the same way as that of the N,N-diethylacrylamide. The sticky product obtained has an average molar mass of about 2500 g/mol and an LCST of 28 to 30° C.

### USE EXAMPLES 1 to 6

A pearlescent pigment (Iriodin Afflair® 504; manufacturer Merck KGaA, Darmstadt) is coated with the LCST polymers of product versions (a) to (f). An appropriate way of quickly investigating the effectiveness of the polymeric coating of particles has proven to be the use of platelet-shaped pearlescent pigments. Since the unmodified form is deposited relatively quickly in water, the improvement in stability as a result of treatment with the LCST polymer of the invention can be assessed within a short time. The altered color effects as well can easily be determined.

### USE EXAMPLE 1

To treat Iriodin Afflair® 504 with the LCST polymer of Example 1 (version (a)) a 0.5% strength polymer solution is used. The pigment (10% by weight) is dispersed in water at 800 rpm for 15 minutes. The dispersion is subsequently cooled to a temperature of 0.5° C. Following the addition of the polymer solution the pigment is coated with the polymer at 11° C. for 30 minutes and the precipitated polymer is then cross-linked for 3 h. The initiator system used is, per gram of polymer, 0.8 g of sodium pyrosulfite, 0.4 g of iron(II) sulfate and 0.8 g of potassium peroxodisulfate. The polymer concentration, based on pigment, was 5% by weight.

### USE EXAMPLE 2

In a similar way, Iriodin Afflair® is treated with the LCST polymer of Example 4 (version (b)), the temperature of the pigment dispersion being raised from 0.5° C. to 11° C. in order to coat the pigment. The polymer layer is crosslinked using the polymerization initiator of Use Example 1 over a period of 3 h.

### USE EXAMPLE 3

In a similar way, Iriodin Afflair® 504 is treated with the LCST polymer of Example 5 (version (c)), the temperature of the pigment dispersion being raised from 0.5° C. to 11° C. in order to coat the pigment. The polymer layer is crosslinked using the polymerization initiator of Use Example 1 over a period of 3 h.

### USE EXAMPLE 4

In a similar way, Iriodin Afflair® 504 is treated with the LCST polymer of Example 6 (version (d)), the temperature of the pigment dispersion being raised from 10° C. to 50° C. in order to coat the pigment. The polymer layer is crosslinked using the polymerization initiator of Use Example 1 over a period of 3 h.

### USE EXAMPLE 5

In a similar way, Iriodin Afflair® 504 is treated with the LCST polymer of Example 7 (version (e)), the temperature of the pigment dispersion being raised from 10° C. to 40° C. in order to coat the pigment. The polymer layer is crosslinked using the polymerization initiator of Use Example 1 over a period of 3 h.

### USE EXAMPLE 6

In a similar way, Iriodin Afflair® 504 is treated with the LCST polymer of Example 8 (version (f)), the temperature of the pigment dispersion being raised from 10° C. to 48° C. in order to coat the pigment. The polymer layer is crosslinked using the polymerization initiator of Use Example 1 over a period of 3 h.

### USE EXAMPLE 7 (COMPARATIVE)

In a similar way, Iriodin Afflair® 504 is treated with the LCST polymer of the comparative example, the temperature of the pigment dispersion being raised from about 0C to 5° C. in order to coat the pigment. The polymer layer is crosslinked using the polymerization initiator of Use Example 1 over a period of 3 h.

The stabilizing effect of the treatment of the pigment with the LCST polymer was assessed according to the sedimentation behavior, by monitoring the settling behavior of the 0.5% by weight pigment dispersion in water. The results of these investigations are depicted in FIGS. 1 and 2. FIGS. 1 and 2 show that both the untreated pigment and the pigment treated with the comparison polymer had settled to a high extent after 60 minutes, whereas the pigment treated with the LCST polymers of the invention showed only slight settling.

The treated pigments were incorporated into a 2-component hydroacrylic-melamine varnish at a concentration of 10% by weight, based on the solids content, by dispersion (peripheral speed 4 m/s, 15° C., 10 min) and investigated for their color properties using an MA 68 Multi-Angle Spectrophotometer colorimeter from X-Rite. The results of these investigations are summarized in Table I.

TABLE I
Color measurements on the treated Iriodin Afflair ® 504
pigment in a hydro varnish

| | Treatment | | | | | |
|---|---|---|---|---|---|---|
| | 15° | | | 25° | | |
| | ΔL | Δa | Δb | ΔL | Δa | Δb |
| Ex. 1 | 2.49 | 2.99 | 0.91 | 1.59 | 0.88 | 0.48 |
| Ex. 2 | 2.33 | 2.72 | 0.75 | 1.47 | 0.82 | 0.41 |
| Ex. 3 | 3.03 | 3.36 | 1.72 | 2.49 | 1.33 | 0.73 |
| Ex. 4 | 2.99 | 3.25 | 1.67 | 2.31 | 1.12 | 0.65 |
| Ex. 5 | 2.01 | 2.23 | 0.64 | 1.13 | 0.68 | 0.25 |
| Ex. 6 | 2.54 | 2.89 | 1.03 | 1.64 | 0.82 | 0.58 |
| Comp. Ex. 7 | 0.09 | −0.16 | 0.21 | 0.03 | −0.08 | 0.14 |

The figures given in Table I were based on the untreated pigment as reference. The state of dispersion and the orientation of the platelet-shaped effect pigments play a distinct role at low viewing angles. It is clearly apparent that the LCST treatment has a positive outcome for the color properties (lightness, hue) of the effect pigment. This can be attributed to the better state of dispersion and the flatter orientation of the pigment particles.

The figures reported for ΔL, Δa and Δb in the inventive examples in Table 1 can be attributed to the orientation of the pigment particles. The pigment treated with the polymer from the comparative example, in contrast, showed lower orientation figures, which are comparable with the figures for the untreated pigment.

### USE EXAMPLE 8

A semiconductor wafer with a silicon dioxide surface measuring 1×1 cm is immersed in 3 ml of distilled water. The system is cooled to 2° C. and 0.2 ml of a 10% strength by weight LCST polymer solution of Example 1 is added. After two hours at 2° C. the system is heated to 23° C. over the course of an hour. Thereafter it is cooled to 2° C. again, though only for a period of 10 minutes, and within an hour is heated to 23° C. This cycle of cooling and heating is carried out a total of three times. After the final cycle the wafer remains at 23° C. in the liquid coating medium for 24 hours and thereafter is rinsed off with distilled water. The polymer layer is subsequently crosslinked under thermal induction; for this purpose the wafer is heated in a drying oven at temperatures of 70-100° C. for 5 hours. Another possibility for crosslinking the polymer layer is to irradiate the coated wafer with intense visible light for 5 hours.

In a similar way the silicon wafer is treated with the LCST polymer of Examples 4 and 5, the temperature range of the polymer solution in the coating operation extending from 2° C. to 23° C. The crosslinking operation takes place in the same way as for the polymer of Example 1.

In a similar way the silicon wafer is treated with the LCST polymers of Examples 6 to 8, the temperature range of the polymer solution in the coating operation extending from 10° C. to 50° C., 10° C. to 40° C. and 10° C. to 48° C., respectively. The crosslinking operation takes place in the same way as for the polymer of Example 1.

The semiconductor wafer coated by the process described above with the LCST polymer now possesses a more strongly hydrophobic surface than a wafer without the coating. This can be documented experimentally by means of water droplets applied to the surface. The coated and therefore more hydrophobic surface is wetted less effectively by water than the unmodified surface. The water droplet beads off from the coated wafer; on the unmodified surface the droplet spreads out.

1. An LCST polymer of the general formula 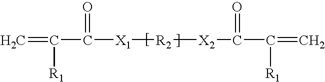
in which R₁ (identical or different at each occurrence) is hydrogen or a methyl group, X₁ and X₂=—O—, —S— or —NH— and X₁ additionally contains a single bond if the first atom in R₂ is not a carbon atom, and R₂ is selected from one of the radicals indicated below:
a) a copolymer radical (Cop) containing at least two structural units —(—O—C₂H₄)ₙ— (ethylene oxide=EO) and —(—O—C₃H₆—)ₙ— (propylene oxide=PO) or —(—O—C₄H₈)ₙ— (butylene oxide=BuO) and —(—O—CH₂—)ₙ— (methylene oxide=MeO) in a molar ratio of 5 to 95:95 to 5, in which n (identical or different for each structural unit) is approximately 1 to 1000;
b) 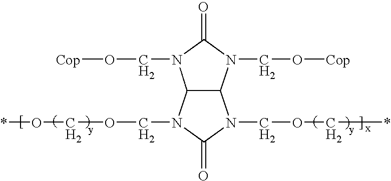
in which Cop is a copolymer radical as defined in (a), and x=1 to 5 and y=1 to 20;
c) 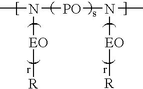
in which R is an alkyl group, r=(identical or different at each occurrence) 1 to 1000 and s=1 to 500;
d) 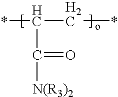
in which o=10 to 4000 and R₃ (identical or different at each occurrence) is hydrogen or alkyl groups having 1 to 5 carbon atoms;
e) 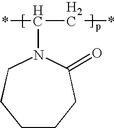
in which p=5 to 2000; or
f) 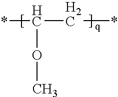
in which q=10 to 4000.

2. The LCST polymer of claim 1, characterized in that the —(C₃H₆)— radical in (a) and (c) is an isopropylene radical and the radical —(C₄H₈)— in (a) is an isobutylene radical.

3. The LCST polymer of claim 1, characterized in that the structural units -(EO)- and-(PO)- and the structural units -(BuO)- and -(MeO)- are present in (a) in blocks with n=1 to 1000.

4. The LCST polymer of claim 3, characterized in that the blocks with the structural units -(PO)- and -(BuO)- are disposed between the blocks with the structural units -(EO)- and -(MeO)-, respectively.

5. A process for preparing an LCST polymer of claim 1 (versions (a) to (c)), comprising reacting a compound of the general formula HO—[R₂]—OH, in which R₂ is as defined in claim 1, is reacted with a compound of the formula 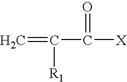
in which R₁ is as defined in claim 1 and X is selected from OH, halogen, an acid group, an acrylic group or a lower alkoxy group, in a molar ratio of 1:1 to 1:4, especially 1:2.

6. A process for preparing an LCST polymer of claim 1 (version c), comprising reacting p-toluenesulfonyl chloride reacted with a polyethylene oxide methyl ester of the formula H-[EO]r-OCH₃, in which r is as defined in claim 1 (c), to give a polyethylene oxide tosylate, reacting the tosylate with (NH₂)—C₃H₆—[-PO-]₅-NH₂, in which s is as defined in claim 1 (c), to give H-[EO]ᵣ-NH-(PO)-NH-(EO)ᵣ-OH, and reacting the resultant product with a compound selected from (a) 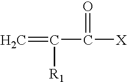
in which R₁ is as defined in claim 1 and X is as defined in claim 5, or (b) with the anhydride of the corresponding acid.

7. (canceled)

8. A process for coating a particle or a non-particulate substrate with a LCST polymer comprising contacting the LCST polymer is contacted in a liquid medium below its LCST temperature with the particles or the nonparticulate substrate, raising the temperature to above the LCST temperature, and polymerizing the polymers via its double bonds at this temperature or a higher temperature on the surface of the particles or on the nonparticulate substrate surfaces.

9. Coated particles or nonparticulate substrates prepared according to the process of claim 8 with the polymerized LCST polymer.

10. The process of claim 5 wherein the halogen is chlorine.
